(19) United States
(12) Patent Application Publication
(10) Pub. No.: US 2015/0052101 A1
(43) Pub. Date: Feb. 19, 2015

(54) ELECTRONIC DEVICE AND METHOD FOR TRANSMITTING FILES

(71) Applicant: HON HAI PRECISION INDUSTRY CO., LTD., New Taipei (TW)

(72) Inventors: JEN-HSIUNG CHARNG, New Taipei (TW); CHI-LING LIN, New Taipei (TW); CHIEN-WEI LEE, New Taipei (TW); I-CHEN LEE, New Taipei (TW)

(21) Appl. No.: 14/460,614

(22) Filed: Aug. 15, 2014

(30) Foreign Application Priority Data
Aug. 16, 2013 (CN) 2013103578447

(51) Int. Cl. H04L 29/08; G06F 17/30

(52) U.S. Cl. CPC H04L 67/10; G06F 17/30091
USPC 707/609; 707/737

(57) ABSTRACT

Method of transmitting files includes acquiring files read by users within a predetermined interval and acquiring file information of the acquired files and user information of users. According to the file information and the user information, the acquired files are classified into groups. Association rules are determined among the groups using a data mining algorithm. A current file read by a current user is acquired. And a group which comprises the current file is determined. According to specified association rules between the determined group and the other groups excepting the determined group, target files are transmit for the current user.

### CROSS-REFERENCE TO RELATED APPLICATIONS

This application claims priority to Chinese Patent Application No. 201310357844.7 filed on Aug. 16, 2013 in the China Intellectual Property Office, the contents of which are incorporated by reference herein.

### FIELD

Embodiments of the present disclosure relate to information transmission technology, and particularly to transmitting files using an electronic device.

### BACKGROUND

Information, such as for example news articles, may be provided using files over the Internet. When a user reads a new article over the Internet, the user may want to read related news articles.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of one embodiment of an electronic device including a transmission system.

FIG. 2 is a diagrammatic view of one embodiment of function modules of the transmission system in the electronic device of FIG. 1.

FIG. 3 illustrates a flowchart of one embodiment of a method for transmitting files in the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

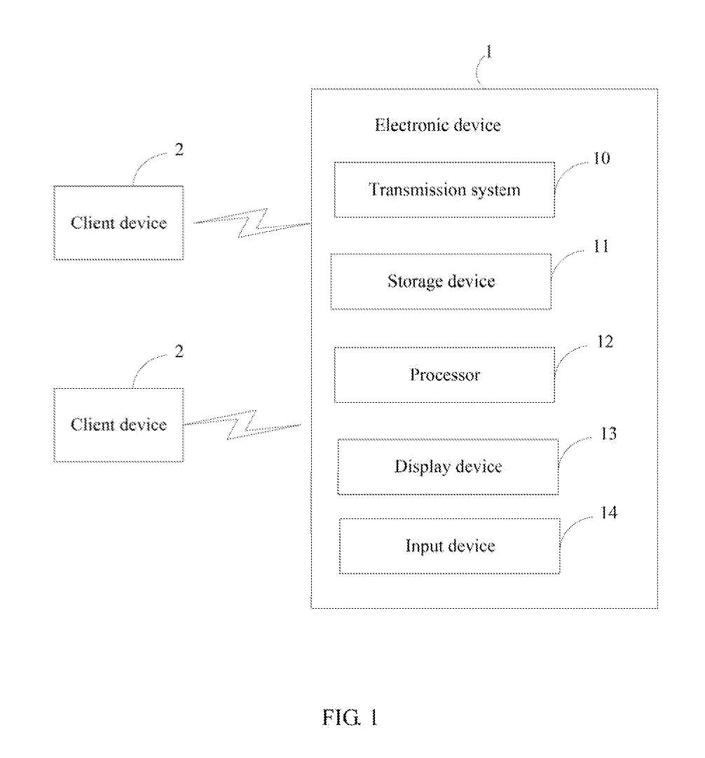

FIG. 1 illustrates a diagrammatic view of one embodiment of an electronic device. Depending on the embodiment, the electronic device 1 includes a transmission system 10. The electronic device 1 is connected to a plurality of client devices 2. A current user can browse files on one of the client devices 2. The electronic device 1 includes, but is not limited to, a storage device 11, at least one processor 12, a display device 13, and an input device 14. The electronic device 1 can be a server, a computer, a smart phone, a personal digital assistant (PDA), or another suitable electronic device. FIG. 1 illustrates only one example of the electronic device that can include more or fewer components than illustrated, or have a different configuration of the various components in other embodiments.

When the current user reads a file on one of the client devices 2, the transmission system 10 can determine other files related to the read file, and transmit the related files to the client device 2 for the current user to read.

In at least one embodiment, the storage device 11 can include various types of non-transitory computer-readable storage mediums, such as a hard disk, a compact disc, a digital video disc, or a tape drive. The display device 13 can display images and videos, and the input device 14 can be a mouse, a keyboard, or a touch panel to input computer-readable data.

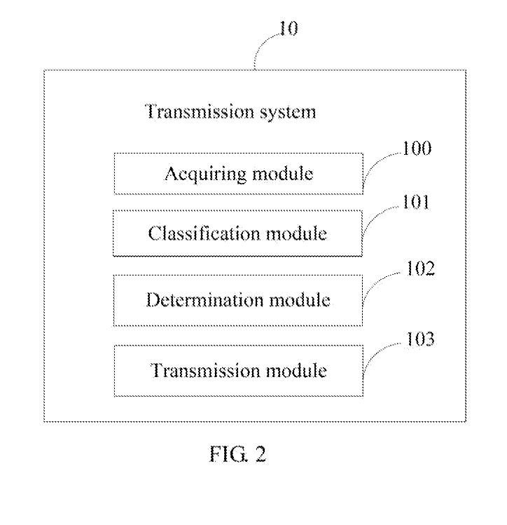

FIG. 2 is a diagrammatic view of one embodiment of function modules of the transmission system. In at least one embodiment, the transmission system can include an acquiring module 100, a classification module 101, a determination module 102, and a transmission module 103. The function modules 100, 101, 102 and 103 can include computerized codes in the form of one or more programs, which are stored in the storage device 11. The at least one processor executes the computerized codes to provide functions of the function modules 100-103.

The acquiring module 100 acquires files read by users within a predetermined interval (e.g., a month), and acquires file information of the acquired files and user information of the users. In at least one embodiment, the file information of each of the acquired files includes, but is not limited to a file identification (ID), a size, keywords of each of the acquired files and a creation time of each of the acquired files. The user information of each of the users includes, but is not limited to a user identification (ID), a start time when starting reading one of the acquired files, an end time when stopping reading one of the acquired files, and a duration of reading each of the acquired files.

The classification module 101 classifies the acquired files into a plurality of groups according to the file information and the user information. In at least one embodiment, the classification module 101 defines one or more keywords for each of the groups, and classifies the acquired files into the groups according to keywords of each of the acquired files. The keywords for each of the groups can be file categories, file contents, Websites, addresses of web pages. For example, it is assumed that group A corresponds to keywords “finance” and “economics,” a read file including a keyword “finance” is classified into the group A using the classification module 101. Each of the acquired files is classified into one or more groups. Each of the groups corresponds to a group number.

The determination module 102 determines association rules among the groups using a data mining algorithm. The data mining algorithm includes an Apriori algorithm. In at least one embodiment, the determination module 102 determines the association rules using a market basket analysis of the Apriori algorithm. Parameters of the Apriori algorithm include a minimum number of item sets, a minimum support value (minsupport), and a minimum continence value (mincontinence). In at least one embodiment, it is assumed that the minimum number of item sets is equal to 2, the minsupport is equal to 0.1, and the mincontinence is equal to 0.2. Each association rule includes one or more groups. For example, it is assumed that a association rule includes a group F and a group E, the group F is associated with group E.

The acquiring module 100 acquires a current file read by a current user, and determines a group which includes the current file. In at least one embodiment, the acquiring module 100 can acquire keywords of the current file. According to the keywords of the current file, the acquiring module 100 determines the group.

The determination module 102 determines target files according to specified association rules between the determined group and the other groups excepting the determined group. For example, there are three groups A, B and C, a current user is reading news on a specified Website, and the specified Website corresponds to the group B. The determination module 102 determines an association rule includes group A and group B. Therefore, the group A is associated with group B. The determination module 102 determines files whose creation time is near to current time in the group A to be the target files. For example, when a time interval between creation time of a file in the group A and the current time is less than or equal to a predetermined time length (e.g., a week . . . ), the file is determined to be the target file.

The transmission module 103 transmits the target files to a client device 2 for the current user.

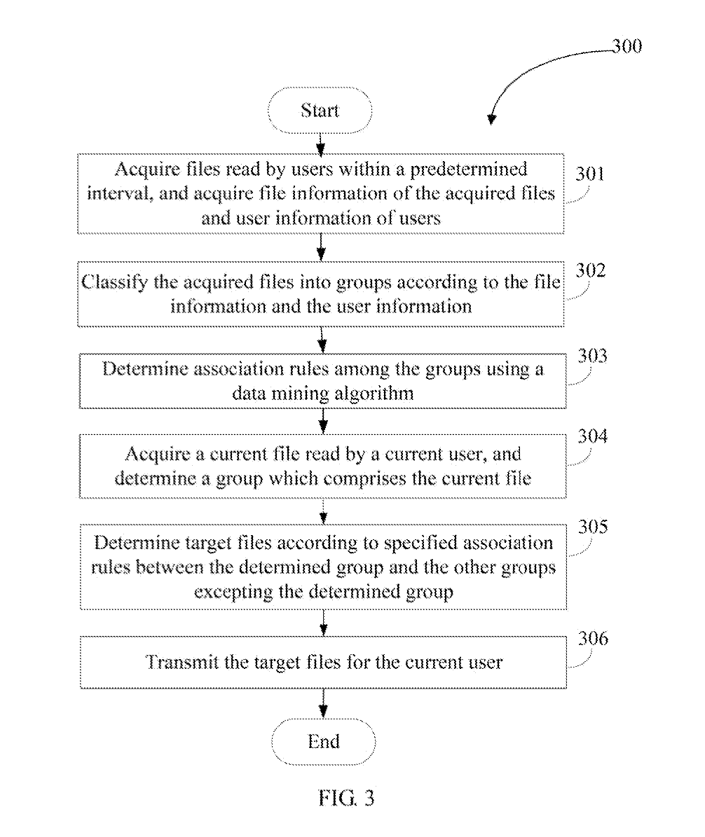

FIG. 3 illustrates a flowchart is presented in accordance with an example embodiment. The example method 300 is provided by way of example, as there are a variety of ways to carry out the method. The method 300 described below can be carried out using the configurations illustrated in FIGS. 1, and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can be changed according to the present disclosure. The exemplary method 300 can begin at block 301. Depending on the embodiment, additional steps can be added, others removed, and the ordering of the steps can be changed.

In block 301, an acquiring module acquires files that have been read by users within a predetermined interval (e.g., a month), and acquires file information of the acquired files and user information of the users. In at least one embodiment, the file information of each of the acquired files includes, but is not limited to a file identification (ID), a size, keywords of each of the acquired files and a creation time of each of the acquired files. The user information of each of the users includes, but is not limited to a user identification (ID), a start time to starting reading one of the acquired files, an end time to stopping reading one of the acquired files, and a duration of reading each of the acquired files.

In block 302, a classification module classifies the acquired files into a plurality of groups according to the file information and the user information. In at least one embodiment, the classification module 101 defines one or more keywords for each of the groups, and classifies the acquired files into the groups according to keywords of each of the acquired files. The keywords for each of the groups can be file categories, file contents, Websites, addresses of web pages. For example, it is assumed that group A corresponds to keywords “finance” and “economics,” a read file including a keyword “finance” is classified into the group A using the classification module 101. Each of the acquired files is classified into one or more groups. Each of the groups corresponds to a group number.

In block 303, a determination module determines association rules among the groups using a data mining algorithm. The data mining algorithm includes an Apriori algorithm. In at least one embodiment, the determination module determines the association rules using a market basket analysis of the Apriori algorithm. Parameters of the Apriori algorithm include a minimum number of item sets, a minsupport, and a mincontinence In at least one embodiment, it is assumed that the minimum number of item sets is equal to 2, the minsupport is equal to 0.1, the mincontinence is equal to 0.2. Each association rule includes one or more groups.

In block 304, the acquiring module acquires a current file read by a current user, and determines a group which includes the current file. In at least one embodiment, the acquiring module can acquire keywords of the current file. According to the keywords of the current file, the acquiring module determines the group.

In block 305, the determination module determines target files according to specified association rules between the determined group and the other groups excepting the determined group. For example, there are three groups, A ,B and C, a current user is reading a news on a specified Website, and the specified Website corresponds to the group B. The determination module determines a association rule includes group A and group B. Therefore, the group A is associated with group B. The determination module 102 determines files created at a time that is near to current time in the group A to be the target files. For example, when a time interval between creation time of a file in the group A and the current time is less than or equal to a predetermined time length (e.g., a week . . . ), the file is determined to be the target file.

In block 306, a transmission module transmits the target files to a client device for the current user.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for transmitting files using an electronic device, the method comprising:
acquiring files read by users within a predetermined interval, and acquiring file information of the acquired files and user information of the users;
classifying the acquired files into groups according to the file information and the user information;
determining association rules among the groups using a data mining algorithm;
acquiring a current file read by a current user, and determining a group which comprises the current file; and
transmitting target files for the current user according to specified association rules between the determined group and other groups excepting the determined group.

2. The method according to claim 1, wherein the file information of each of the acquired files comprises a file identification (ID), a size, keywords of each of the acquired files and a creation time of each of the acquired files.

3. The method according to claim 1, wherein the user information of each of the users comprises a user identification (ID), a start time when starting reading one of the acquired files, an end time when stopping reading one of the acquired files, and a duration of reading each of the acquired files.

4. The method according to claim 1, wherein the acquired files are updated after the predetermined interval, and the association rules are updated according to the updated acquired files.

5. The method according to claim 1, wherein the data mining algorithm comprises an Apriori algorithm, the association rules are determined using a market basket analysis of the Apriori algorithm.

6. The method according to claim 2, wherein the acquired files are classified into groups according to the keywords of each of the acquired files, each of the acquired files is classified into one or more groups.

7. An electronic device, comprising:
a processor; and
a storage device that stores one or more programs, when executed by the at least one processor, cause the at least one processor to:
acquire files read by users within a predetermined interval, and acquire file information of the acquired files and user information of the users;
classify the acquired files into groups according to the file information and the user information;
determine association rules among the groups using a data mining algorithm;
acquire a current file read by a current user, and determine a group which comprises the current file; and
transmit target files for the current user according to specified association rules between the determined group and other groups excepting the determined group.

8. The electronic device according to claim 7, wherein the file information of each of the acquired files comprises a file identification (ID), a size, keywords of each of the acquired files and a creation time of each of the acquired files.

9. The electronic device according to claim 7, wherein the user information of each of the users comprises a user identification (ID), a start time when starting reading one of the acquired files, an end time when stopping reading one of the acquired files, and a duration of reading each of the acquired files.

10. The electronic device according to claim 7, wherein the acquired files are updated after the predetermined interval, and the association rules are updated according to the updated acquired files.

11. The electronic device according to claim 7, wherein the data mining algorithm comprises an Apriori algorithm, the association rules are determined using a market basket analysis of the Apriori algorithm.

12. The electronic device according to claim 8, wherein the acquired files are classified into groups according to the keywords of each of the acquired files, each of the acquired files is classified into one or more groups.

13. A non-transitory storage medium having stored thereon instructions that, when executed by a processor of an electronic device, causes the processor to perform a method for transmitting files, wherein the method comprises:
acquiring files read by users within a predetermined interval, and acquiring file information of the acquired files and user information of the users;
classifying the acquired files into groups according to the file information and the user information;
determining association rules among the groups using a data mining algorithm;
acquiring a current file read by a current user, and determining a group which comprises the current file; and
transmitting target files for the current user according to specified association rules between the determined group and other groups excepting the determined group.

14. The non-transitory storage medium according to claim 13, wherein the file information of each of the acquired files comprises a file identification (ID), a size, keywords of each of the acquired files and a creation time of each of the acquired files.

15. The non-transitory storage medium according to claim 13, wherein the user information of each of the users comprises a user identification (ID), a start time when starting reading one of the acquired files, an end time when stopping reading one of the acquired files, and a duration of reading each of the acquired files.

16. The non-transitory storage medium according to claim 13, wherein the acquired files are updated after the predetermined interval, and the association rules are updated according to the updated acquired files.

17. The non-transitory storage medium according to claim 13, wherein the data mining algorithm comprises an Apriori algorithm, the association rules are determined using a market basket analysis of the Apriori algorithm.

18. The non-transitory storage medium according to claim 14, wherein the acquired files are classified into groups according to the keywords of each of the acquired files, each of the acquired files is classified into one or more groups.
